(19) United States
(12) Patent Application Publication
(10) Pub. No.: US 2004/0001921 A1
(43) Pub. Date: Jan. 1, 2004

(54) Coating in an environment that includes solvent vapor

(75) Inventors: William Blake Kolb, Woodbury, MN (US); Gary L. Huelsman, St. Paul, MN (US); Thomas M. Milbourn, Mahtomedi, MN (US); Timothy J. Edman, Stillwater, MN (US); Joseph F. Fuller, Vadnais Heights, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 10/179,587

(22) Filed: Jun. 26, 2002

(51) Int. Cl. B05D 1/02

(52) U.S. Cl. 427/421; 118/68; 118/325

(57) ABSTRACT

The invention is generally directed to techniques for reducing premature drying of solvent-based coatings, including premature drying at sites on the apparatus that applies the coatings. By introduction of solvent vapor proximate to the coating apparatus, and by passively bringing the solvent vapor to the site, the risk of premature drying is reduced. In the presence of the solvent vapor, solvent in the coating fluid tends not to evaporate quickly. The solvent vapor may be introduced by any of a variety of solvent vapor emission devices, and may be brought to the site passively by, for example, increasing the concentration of solvent vapor in a boundary layer that moves with the substrate being coated, diffusion, or natural convection.

### TECHNICAL FIELD

The present invention relates to coating methods and, more particularly, to methods for coating fluid layers on a substrate.

### BACKGROUND

Data storage media such as magnetic tape and diskettes typically are manufactured by coating one or more magnetic layers on a substrate, and then drying the resultant coating to form a film. For manufacturing reasons, the substrate ordinarily takes the form of a moving web that is transported relative to a generally fixed coating apparatus. In an effort to store increased amounts of information, it is desirable to provide higher density magnetic recording media. Higher density can be achieved by including increased amounts of magnetic particles in the magnetic layer, adding additional magnetic layers, using thinner layers, or providing magnetic particles capable of increased data storage density.

The substrate may be provided with a subbing layer that is typically situated between the substrate and the magnetic layer. A subbing layer can promote adhesion between the substrate and the magnetic layer, whether the media contains one or more magnetic layers. Thus, a magnetic recording medium may contain a subbing layer and one or more magnetic layers thereon, resulting in a multi-layer construction.

Producing magnetic recording media with a multi-layer construction typically has involved sequential coating and drying steps, adding one layer during each coating application. Existing coating techniques include roll coating, gravure coating, extrusion coating, and a combination thereof, to name a few. Multi-layer coating techniques also exist. For manufacturing reasons, coatings are often applied in liquid form, with the coating material dissolved in a solvent. Following application, the solvent evaporates, leaving behind the coating substances on the substrate. It is often desirable that the coating substances be applied smoothly and uniformly.

Many of these coating techniques can pose difficulties. For example, coatings such as organic solvent-based polymer coatings may dry prematurely, before the coating can be applied to the substrate. In drying, the liquid solvent evaporates, leaving behind a coating solute at a site other than the substrate. In particular, the coating substances may tend to dry on or around parts of the mechanical apparatus used to apply the coating. Coating substances are especially prone to dry proximate to static contact lines, i.e., sites at which the liquid coating contacts the apparatus and the liquid is not moved away from the apparatus by the coating process. Dried coating substances on the coating apparatus interferes with the smooth and uniform application of the solvent-based coating, and as a result, the quality of the layers may be impaired. Premature drying can be problematic in other respects as well.

### SUMMARY

In general, the invention pertains to techniques for reducing premature drying of solvent-based coatings. More particularly, the techniques of the invention are directed to decreasing premature drying on the apparatus that applies the coatings. The invention generally involves the introduction of solvent vapor proximate to the coating apparatus. The devices that introduce the solvent vapor do not force the solvent vapor toward the site on the coating apparatus where premature drying may occur. Rather, the solvent vapor is delivered to the site passively.

The solvent vapor may be brought to the site passively in several ways. For example, the solvent vapor may arrive at the site by diffusion. In one exemplary application of the invention, solvent vapor is introduced inside a hood that covers a coating apparatus, and the atmosphere inside the hood acquires a higher concentration of solvent vapor by diffusion.

The solvent vapor may also be brought to the site by the motion of the substrate. Many coating methods move a substrate past the coating apparatus. As the substrate moves, a boundary layer of air forms due to the natural viscosity of air. This air, when brought in contact with the solvent-based coating, may cause the coating to dry prematurely. The invention may include techniques for supplanting at least some of the air in the boundary layer with the solvent in vapor form. The boundary layer continues to move with the substrate to the coating apparatus, but the boundary layer comprises solvent vapor. The motion of the substrate may also generate convective circulation that moves the solvent vapor. In these ways, the motion of the substrate brings the solvent vapor to the site.

In addition, the solvent may be brought to the site by natural convection. Natural convection includes motion due to thermal gradients, gravity or buoyancy. When the solvent vapor is heavier than air, for example, gravity may bring the solvent to the site.

In one embodiment, the invention provides a method comprising dispensing a solvent-based liquid coating with a coating apparatus, and introducing solvent vapor proximate to a site at which the liquid coating comes in contact with the coating apparatus. The solvent vapor is passively brought to the site, such as by diffusion, natural convection or in the boundary layer that moves with the substrate.

In another embodiment, the invention is directed to an apparatus. The apparatus includes a coating apparatus, and the coating apparatus includes an exposed surface that comes in contact with a liquid coating that includes a solvent. The apparatus further includes a solvent vapor emission device that emits solvent vapor. The solvent vapor emission device is positioned such that the emitted solvent vapor is passively brought to the exposed surface. The solvent vapor emission device may be embodied as an energy transfer element that evaporates liquid solvent to emit solvent vapors, for example, or as a device that draws solvent from a reservoir with capillary forces and emits solvent vapor by evaporation. The solvent vapor emission device may be embodied as a saturated gas jet that blows gas including solvent in vapor form onto a moving substrate. The solvent vapor may be brought to the coating apparatus as part of a boundary layer adhering to the substrate.

In additional embodiments, the invention is directed to solvent vapor emission devices. More than one solvent vapor emission device may be used, and devices of different kinds may be employed in combination. In one embodiment of a device that emits solvent vapor, the device includes a first tube containing a fluid and a second tube containing a liquid solvent. The liquid solvent receives energy from the first tube and vaporizes to produce solvent vapor. The solvent vapor escapes through one or more apertures in the second tube. In another embodiment of a device that emits solvent vapor, the device includes a reservoir of liquid solvent and a material that draws the liquid solvent with capillary forces from the reservoir to a target area. Near the target area, the apparatus emits solvent vapor by evaporation.

The invention may provide one or more advantages. As will be shown below, the invention may be applied with different coating techniques, including slide coating, extrusion coating, fluid bearing coating and curtain coating. The increased concentration of solvent vapor near the coating apparatus reduces the occurrence of premature drying that can cause to surface defects, resulting in a high quality coating. In addition, because the solvent vapor may be introduced to the coating apparatus passively, the introduction of the solvent vapor is unlikely to disrupt the coating process.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a cross-sectional side view of a slide coating apparatus illustrating alternative embodiments of the invention.

FIG. 2 is a perspective cutaway view of an exemplary solvent vapor emission device that delivers solvent vapor by evaporation of solvent liquid.

FIG. 3 is a perspective view of an exemplary solvent vapor emission device that delivers solvent vapor with capillary material.

FIG. 4 is a cross-sectional side view of an extrusion coating apparatus illustrating alternative embodiments of the invention.

FIG. 5 is a cross-sectional side view of a fluid bearing coating apparatus illustrating alternative embodiments of the invention.

FIG. 6 is a cross-sectional side view of a curtain coating apparatus illustrating an embodiment of the invention.

### DETAILED DESCRIPTION

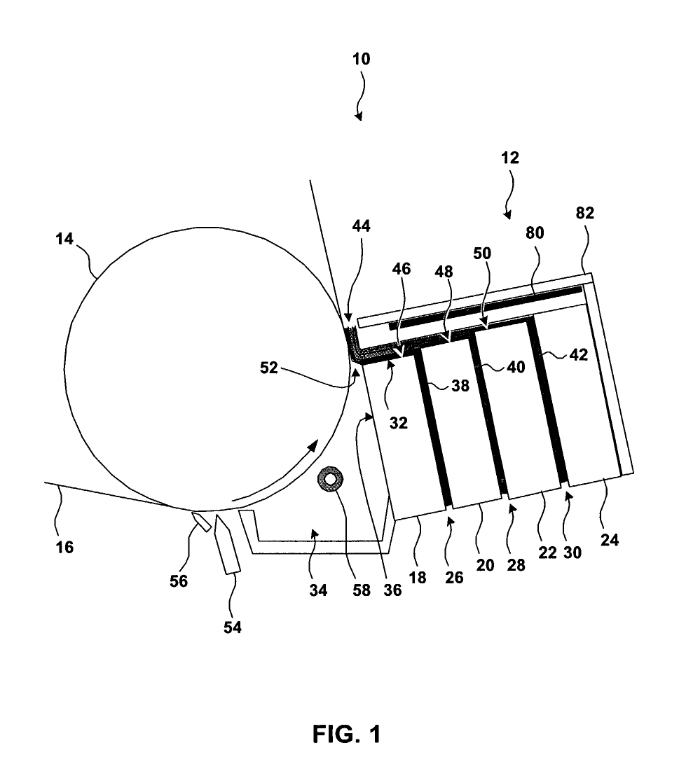

FIG. 1 is a cross-sectional side view of a slide coating apparatus 10 suitable for practice of a coating method in accordance with the present invention. Slide coating apparatus 10 includes a slide coater 12. A backup roller 14 can be provided proximate slide coater 12 to support a coating substrate 16 in the form of a continuous web. Backup roller 14 rotates in the direction of travel of substrate 16. Substrate 16 can be transported relative to slide coater 12 between supply and takeup rolls (not shown). Slide coater 10 can simultaneously coat two or more fluid layers in a stacked arrangement onto substrate 16. Following coating, the layers are dried, e.g., by transportation of substrate 16 through a drying oven (not shown).

Slide coater 12 may include multiple slide blocks 18, 20, 22, 24. In the embodiment of FIG. 1, slide coater 12 includes four slide blocks. In other embodiments, slide coater 12 may include fewer or more than four slide blocks, depending on the number of fluid layers to be coated onto substrate 16. In some embodiments, for example, the recording medium to be manufactured may include only a single recording layer.

Slide blocks 18, 20, 22, 24 define fluid slots 26, 28, 30 and a combined slide surface 32. First slide block 18 is disposed adjacent back-up roller 14, while slide blocks 20, 22, 24 are disposed upward from the first slide block 18. Slide blocks 18, 20, 22 define a continuous slide surface for flow of coating fluids.

A vacuum box 34 can be provided to adjust the level of negative pressure adjacent slide coating apparatus 10. In particular, vacuum box 34 serves to maintain a differential pressure across the coating bead 52 between slide surface 32 and substrate 16, thereby stabilizing coating bead 52. Vacuum box 34 also surrounds face 36 of slide block 18. Vacuum box 34 may be coupled to a vacuum source (not shown in FIG. 1) and include an outlet (not shown in FIG. 1) for material recovered from the coating area.

A first fluid 38 can be distributed to first slot 26 via a first fluid supply and a first manifold (not shown in FIG. 1). A second fluid 40 can be distributed to second slot 28 via a second fluid supply and a second manifold (not shown in FIG. 1). A third fluid 42 can be distributed to third fluid slot 30 via a third fluid supply and a third fluid manifold (not shown in FIG. 1). Thus, in an embodiment as shown in FIG. 1, slide coater 12 is capable of coating a three-layer fluid construction 44 that includes a first fluid layer 46 containing first fluid 38, a second fluid layer 48 containing second fluid 40, and a third fluid layer 50 containing third fluid 42. First fluid layer 46 can be coated onto substrate 16, with second fluid layer 48 being coated above first fluid layer 46, and third fluid layer 50 being coated above second fluid layer 48.

Fluids 38, 40, 42 may comprise a solvent plus a solute. Typical solvents may include, for example, tetrahydrofuran, methylene chloride, acetone, methyl ethyl ketone, methyl isobutyl ketone, ethyl acetate, butyl acetate, cyclohexanone, butyl alcohol, N,N-dimethylformamide, toluene, and mixtures thereof. When the solvent dries, the coating solute remains behind. In other words, coatings are applied as liquids for ease of application, but the coatings are dry in the finished product.

The type of solute carried by fluids 38, 40, 42 depends on the type of coating to be formed. In the manufacture of magnetic storage media, for example, the solute may include a plurality of magnetic particles. The magnetic particles may be acicular or needle-like magnetic particles with an average length along the major axis of less than about 0.3 nm. Typical acicular particles of this type include, for example, particles of ferro- and ferromagnetic iron oxides such as gamma-ferric oxide (γ-Fe₂O₃), complex oxides of iron and cobalt, various ferrites and metallic iron particles. Alternatively, small tabular particles such as barium ferrites and the like can be employed. The particles can be doped with one or more ions of a polyvalent metal such as titanium, tin, cobalt, nickel, zinc, manganese, chromium, or the like. First fluid layer 46 may act as a carrier or “subbing” layer for second and third fluid layers 48, 50. In this case, the wet thickness of first fluid layer 48 on substrate 16 may be substantially more than the wet thicknesses of second and third fluid layers 48, 50. The wet thickness of each layer 46, 48, 50 is the average cross-substrate thickness on the surface of coated substrate 16 at a point substantially removed from the coating bead 52, but close enough that appreciable drying has not yet occurred.

The widths of fluid slots 26, 28, 30 in a direction transverse to the direction of flow of fluid layers 46, 48, 50 may be substantially commensurate with the width of substrate 16. Slide blocks 18, 20, 22 may be slightly wider than fluid slots 26, 28, 30. In some embodiments, the width of substrate 16 may be on the order of 6 to 30 inches (15.24 cm to 76.2 cm). In producing magnetic tape media, substrate 16 may be slit length-wise following coating into several strips, e.g., one-quarter inch (0.64 cm) in width, to produce continuous lengths of recording tape for loading into data cartridges. In producing magnetic disk media, disks can be cut or punched from substrate 16 as “cookies,” e.g., 3.5 inches (90 mm) in diameter, for loading into floppy diskette housings. In either case, each fluid layer 46, 48, 50 preferably extends width-wise to the lateral edges of substrate 16.

In some embodiments, second fluid 40 contains magnetic material such as metal magnetic recording particles. In this case, once dried, second fluid layer 48 forms a magnetic recording layer on substrate 16. In other embodiments, the magnetic material can be provided in first fluid layer 46, or in multiple fluid layers 46, 48, 50 of fluid construction 44. For example, multiple layers in fluid construction 44 may form multiple magnetic recording layers. Alternatively, individual magnetic layers can be arranged to work together as a composite multi-layer recording film.

Third fluid 42 may contain a variety of different substances that contribute to the functional properties of the finished magnetic recording medium. In other words, once dried, third fluid layer 50 may form a functional layer of the magnetic recording medium. For example, third fluid 42 may contain antistatic material, abrasive material that aids the cleaning of recording heads during use, lubricating materials that reduce friction between the magnetic recording head and the surface of the magnetic recording medium, or a combination thereof.

Additional slide blocks can be added to slide coater 12 for the introduction of additional fluid layers, as desired for media performance, ease of coatability, or productivity. Thus, such functional materials can be incorporated in discrete fluid layers. Alternatively, one or more functional materials can be incorporated in a single fluid that, when dried, forms a multi-functional layer in the resulting magnetic recording medium.

In conventional slide coating, the moving uncoated substrate 16 carries with it a boundary layer of air. The boundary layer forms naturally due to the viscosity of air. The boundary layer results from air molecules attaching to substrate 16. As substrate 16 moves, substrate 16 draws air along. The boundary layer does not dissipate of its own accord, and passage through vacuum box 34 ordinarily does not remove the boundary layer.

The boundary layer of air may create difficulties with premature drying of fluid layers 46, 48, 50. In particular, solvent in fluid layers 46, 48, 50 evaporates in the presence of air, leaving behind a coating of solute. The coating substances may therefore tend to dry on or around parts of the coating apparatus, such as slide surface 32 or face 36 of slide block 18 close to substrate 16. Generally speaking, premature drying occurs when solvents evaporate while the coating solution is still in contact with the surface of slide coating apparatus 10. Premature drying is prone to take place proximate to static contact lines. Dried coating interferes with the smooth flow of fluids 46, 48, 50, causing undesirable artifacts such as streaks, voids and bands. Such defects can have a major impact on yields from the coating process because, by their presence, they render the coated substrate unusable.

Slide coating apparatus 10 may include a saturated gas jet 54 located proximate to substrate 16. In the exemplary embodiment shown in FIG. 1, saturated gas jet 54 is positioned just outside vacuum box 34. Saturated gas jet 54 blows saturated gas, i.e., gas including solvent in vapor form, onto substrate 16, disrupting the boundary layer of air the moves with substrate 16. In particular, saturated gas jet 54 acts as a wiper that supplants the boundary layer of air, at least in part, with a boundary layer of saturated gas. In other words, saturated gas jet 54 increases the concentration of solvent vapor in the boundary layer that forms naturally next to moving substrate 16. The saturated gas includes solvent in vapor form, but the saturated gas need not be completely saturated. The invention encompasses embodiments in which the saturated gas includes a wide range of concentrations of solvent vapor.

The boundary layer having the increased concentration of solvent vapor is drawn by the motion of substrate 16 to slide coater 12. The motion of substrate 16 may also generate convective circulation that moves the solvent vapor. The solvent vapor is not blown directly at slide coater 12 by saturated gas jet 54. That is, saturated gas jet 54 increases the concentration of solvent vapor in the boundary layer, and the boundary layer with the increased concentration of solvent vapor is drawn passively to slide coater 12. In the presence of the solvent vapor, solvent in fluid layers 46, 48, 50 tends not to evaporate quickly and leave behind solute on slide coating apparatus 10.

The concentration of solvent vapor in the boundary layer may be regulated by controlling saturated gas jet 54. For example, the concentration of solvent vapor in the boundary layer may be a function of the concentration of solvent vapor in the saturated gas emitted by saturated gas jet 54. The pressure at which saturated gas jet 54 blows saturated gas onto substrate 16, and the angle at which saturated gas jet 54 blows saturated gas onto substrate 16 likewise may affect the concentration of solvent vapor in the boundary layer.

Saturated gas jet 54 may be used in conjunction with a skive blade 56 that skims off a portion of the boundary layer of air from substrate 16. Skive blade 56 may take the form of a blade-like member that extends laterally across the width of substrate 16. Skive blade 56 may extend further than the width of substrate 16. Skive blade 56 may be contacting or non-contacting relative to substrate 16, but preferably presents a leading edge that is positioned closely adjacent the surface of substrate 16.

The saturated gas may be saturated with the solvent that carries the coatings. That is, the saturated gas includes a substantial component of solvent vapor. Although the gas need not be completely saturated, higher solvent vapor concentrations will be more effective in reducing drying. The gas that carries the solvent vapor may be air, but because of safety considerations, the carrier gas may be a non-flammable or non-reactive gas, such as helium or nitrogen.

The saturated gas may be emitted with sufficient pressure to act as an air knife that skives the boundary layer of air, and replaces the boundary layer of air with a boundary layer of solvent vapor. Alternatively, the saturated gas may be emitted at a lower pressure to intermix with the boundary layer of air carried by the surface of substrate 16. In either case, the introduction of saturated gas is useful in providing an environment that resists drying, and reduces the possibility of drying-induced coating streaks and other defects.

The saturated gas preferably is not directed at coating bead 52, because directing a jet of gas at coating bead 52 may disrupt the coating. Instead, saturated gas jet 54 is directed at substrate 16, so that the boundary layer comprises less air and more solvent vapor. The boundary layer attaches to substrate 16 and is passively drawn at the same speed as substrate 16. Substrate 16 brings the saturated gas to coating bead 52. In this way, coating bead 52 is exposed to saturated gas because of the motion of substrate 16, rather than because of directed flow from saturated gas jet 54.

In addition to or as an alternative to saturated gas jet 54, slide coating apparatus 10 may include other solvent vapor emission structures that introduce solvent vapor proximate to the site where coatings are applied to substrate 16 by slide coating apparatus 10. One such solvent vapor emission structure is solvent vapor emission device 58 inside vacuum box 34. Solvent vapor emission device 58 may be positioned to extend laterally across the width of substrate 16 to create an environment that includes solvent vapor. Solvent vapor emission device 58 may be longer than the width of substrate 16.

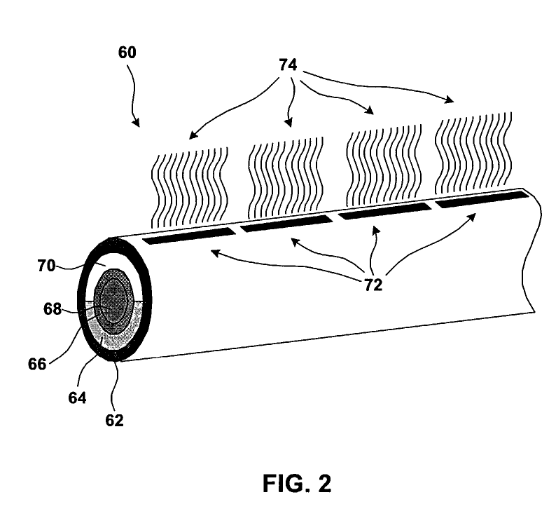

FIG. 2 illustrates an exemplary embodiment 60 of solvent vapor emission device 58. Solvent vapor emission device 60 comprises an outer tube 62, which carries liquid solvent 64. Solvent vapor emission device 60 further comprises an inner tube 66, which may transfer energy to liquid solvent 64. In the embodiment shown in FIG. 2, inner tube 66 carries an energy transfer element 68. Energy transfer element 68 may be, for example, a heated fluid such as hot water. Inner tube 66 may be thermally conductive. Energy transfer element 68 causes liquid solvent 64 to undergo a state change and enter a vapor form 70. Outer tube 62 includes slots 72 that allow vapor 74 to escape. Escaped vapor 74 increases the solvent vapor content in the surrounding environment.

The concentration of solvent vapor may be regulated via control of energy transfer element 68. The vapor pressure of the solvent varies directly with temperature. Consequently, the more energy introduced to liquid solvent 64 by energy transfer element 68, the more solvent evaporates, producing solvent vapor 70, 74.

Solvent vapor emission device 60 in FIG. 2 is merely one example of solvent vapor emission device 58 in FIG. 1. Solvent vapor emission device 58 may be also realized by, for example, a heated or unheated evaporation pan, spray nozzle, or a gas jet similar to saturated gas jet 54. Solvent vapor emission device 58 does not direct solvent vapor at coating bead 52, but rather increases the solvent vapor concentration in the environment around coating bead 52. Consequently, the boundary layer proximate to substrate 16 comprises less air and more solvent vapor. As a result, substrate 16 brings the solvent vapor to coating bead 52, and solvent vapor is passively drawn toward coating bead 52.

The placement of solvent vapor emission device 58 in vacuum box 34 shown in FIG. 1 is merely exemplary. Solvent vapor emission device 58 may be located anywhere in vacuum box 34. Solvent vapor emission device 58 may be located, for example, closer to coating bead 52. More than one solvent vapor emission device 58 may be located in vacuum box 34.

In addition to or as an alternative to saturated gas jet 54 and solvent vapor emission device 58 in vacuum box 34, slide coating apparatus 10 may include a solvent vapor emission device 80 proximate to the slide surfaces of slide coater 12. Solvent vapor emission device 80 is typically separated from the outside environment by hood 82.

Solvent vapor emission device 80 does not replace the boundary layer drawn by substrate 16. Rather, solvent vapor emission device 80 delivers solvent vapor to the region around the slide surfaces of slide blocks 18, 20, 22, 24. Solvent vapor emission device 80 retards premature drying that may occur as fluids 46, 48, 50 flow toward substrate 16. Premature drying in this location may cause undesirable artifacts such as streaks, voids and bands that may render the coated substrate unusable. Hood 82 protects the region exposed to solvent vapor, and prevents the solvent vapor from dissipating.

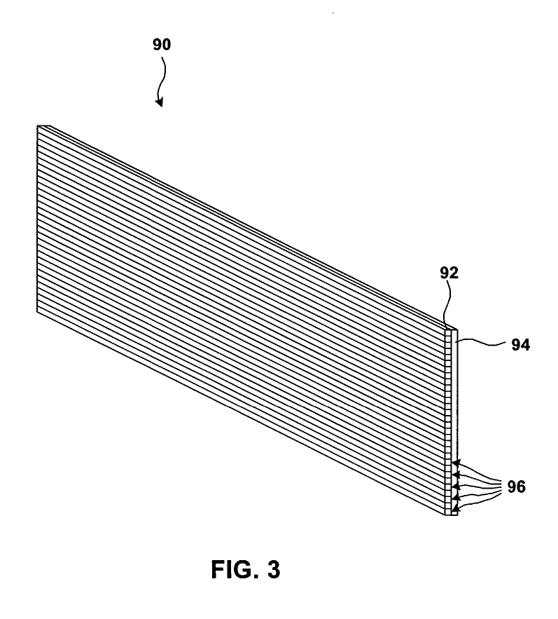

FIG. 3 illustrates an exemplary embodiment 90 of solvent vapor emission device 80. In the example of FIG. 3, solvent vapor emission device 90 takes the form of a capillary material that delivers solvent vapor to the environment around the slide surfaces of slide coater apparatus 12. The use of a capillary material may be desirable to avoid defects that can be caused by movement of gas across the surface of the fluids 46, 48 50 accumulated on the slide surface of slide coater 12. Gas movement across the slide surface can disrupt the surface of the coating on substrate 16, creating patterns that lead to defects in the coated product. The use of a capillary material as the vehicle for emitting solvent vapor may be less disruptive and avoid defects in the coated product.

The capillary material may take the form of a sheet 92 that is supported on a baseplate 94. Baseplate 94 may be mounted to the interior of hood 82 (shown in FIG. 1) using screws, brackets, adhesives and the like. Sheet 92 of capillary material may have small channels 96 that wick solvent from a solvent source (not shown in FIG. 3) to an area proximate the slide coater surface. Alternatively, sheet 92 of capillary material may take the form of, for example, a porous foam material, an absorbent paper product, or a piece of absorbent cloth. In each case, the capillary forces, i.e., surface tension, force solvent toward the outer surface of the capillary material, where the solvent evaporates to promote a higher concentration of solvent vapor in the region of the slide coater surface.

Solvent may be delivered laterally into channels 96 of sheet 92 of capillary material. The solvent can be delivered using a drip pan or other reservoir (not shown in FIG. 3) into which one end of the sheet 92 of capillary material is positioned. The reservoir may be placed remotely from coating bead 52. In this manner, sheet 92 of capillary material wicks and distributes the solvent from the reservoir and transports it in a direction toward coating bead 52. As the solvent evaporates from sheet 92 of capillary material, it increases the solvent vapor concentration of the environment above the slide surfaces and beneath hood 82, reducing the incidence of drying and associated coating defects.

FIG. 1 shows saturated gas jet 54, solvent vapor emission device 58 in vacuum box 34 and solvent vapor emission device 80 proximate to the slide surfaces of slide coater 12. Slide coating apparatus 10 may employ any of these solvent vapor emission structures individually or in concert with others.

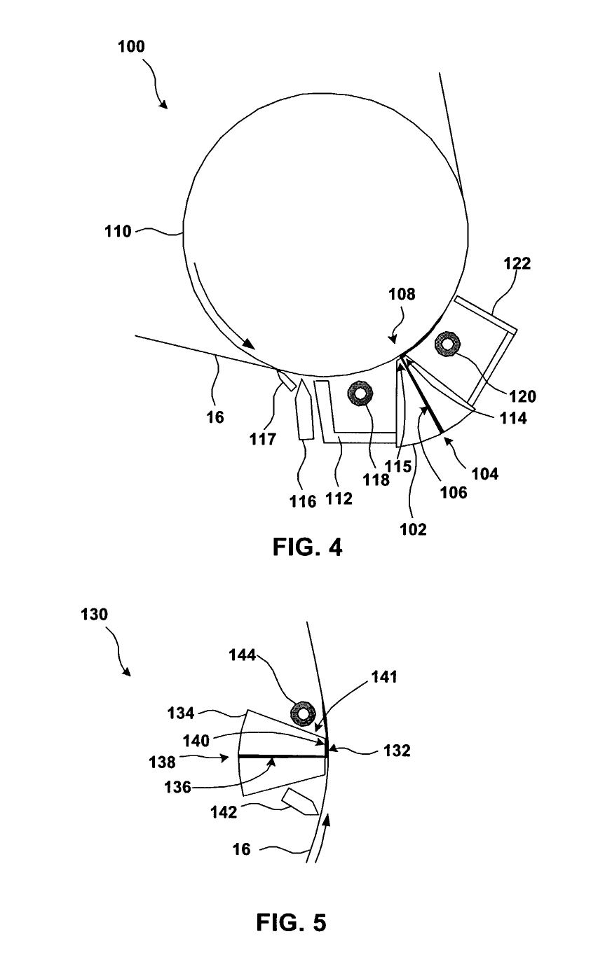

FIG. 4 is a side cross-sectional diagram of an extrusion coating apparatus 100. The invention may be practiced with extrusion coating apparatus 100. Extrusion coating apparatus 100 includes an extrusion die 102. A coating fluid 104 can be distributed to slot 106 in die 102 from a fluid supply (not shown in FIG. 4). Fluid 104 is extruded from die 102 and forms a coating bead 108, which coats substrate 16. Backup roller 110 may support substrate 16 proximate to die 102. Extrusion coating apparatus 100 may include a vacuum box 112 similar to vacuum box 34 shown in FIG. 1.

As with slide coating apparatus 10 shown in FIG. 1, substrate 16 coated with extrusion coating apparatus 100 may carry a boundary layer of air. The boundary layer of air may cause premature drying of fluid 104. In particular, solvent in fluid 104 may evaporate, leaving behind a coating of solute on the downstream face 114 of die 102 and/or on the upstream face 115 of die 102 proximate to substrate 16. Premature drying may interfere with the quality of the coating.

Extrusion coating apparatus 100 may include one or more solvent vapor emission structures that introduce solvent vapor proximate to the site where the coating is applied to substrate 16. FIG. 4 shows, for example, a saturated gas jet 116 and a skive blade 117, which are similar to saturated gas jet 54 and skive blade 56 shown in FIG. 1. Saturated gas jet 116 replaces the boundary layer of air on substrate 16 with a boundary layer of saturated gas, i.e., gas having solvent vapor. This saturated gas boundary layer is drawn passively by substrate 16 to coating bead 108. In the presence of the solvent vapor, solvent in fluid 104 tends not to evaporate quickly and leave behind solute on faces 114 and/or 115 of die 102.

As shown in FIG. 4 extrusion coating apparatus 100 may include a solvent vapor emission device 118. Solvent vapor emission device 118 is located in vacuum box 112. Solvent vapor emission device 118 affects the boundary layer and retards drying on faces 114 and/or 115 of die 102. Extrusion coating apparatus 100 may also include a solvent vapor emission device 120 inside a hood 122, which does not affect the boundary layer but retard drying on faces 114 and/or 115 of die 102. Solvent vapor emission devices 118, 120 may be similar to solvent vapor emission device 60 shown in FIG. 2 or solvent vapor emission device 90 shown in FIG. 3. Solvent vapor emission device 118 need not be of the same kind as solvent vapor emission device 120. Solvent vapor emission devices 118, 120 do not actively direct solvent vapor at coating bead 108 or faces 114 and 115 of die 102. Rather, solvent vapor emission devices 118, 120 introduce the solvent vapor into the environment, and the solvent vapor is passively drawn to coating bead 108 and/or faces 114, 115 of die 102 by the motion of substrate 16, the motion of fluid 104, or by diffusion.

In some embodiments of the invention, solvent vapor emission devices 118, 120 may be positioned so that the solvent may be brought to coating bead 108 and/or faces 114, 115 of die 102 by natural convection. Natural convection includes motion due to gravity or buoyancy. Solvent vapor may move downward when the solvent vapor is heavier than air, for example, and may be buoyed upward when the solvent vapor is lighter than air. The density of the solvent vapor may be a function of temperature. Natural convection may also include motion due to thermal gradients.

Solvent vapor emission structures 116, 118, 120 may be employed individually or any in concert with others. Each solvent vapor emission structure 116, 118, 120 introduces solvent vapor into regions proximate to coating bead 108 to reduce premature drying of solvent around die 102.

The invention may further be practiced in connection with a fluid bearing coating apparatus 130 as shown in FIG. 5. Instead of being supported by a backup roller, substrate 16 is held in tension between supply and takeup rolls (not shown in FIG. 5) and is borne by a coating bead 132 extruded from die 134. Die 134 includes a slot 136 that distributes coating fluid 138.

Substrate 16 may carry a boundary layer of air as substrate 16 approaches die 134. The boundary layer of air may cause premature drying of fluid 138, particularly on the face 140 of die 134, and/or on lateral surface 141 of die 134. To reduce premature drying, fluid bearing coating apparatus 130 may include one or more solvent vapor emission structures that introduce solvent vapor proximate to the site where the coating is applied to substrate 16. Fluid bearing coating apparatus 130 may include, for example, a saturated gas jet 142 and a solvent vapor emission device 144. Solvent vapor emission structures 142, 144 introduce solvent vapor into regions proximate to coating bead 132 to reduce premature drying of solvent. Solvent vapor emission devices 142, 144 do not actively direct solvent vapor at coating bead 132 or die 134. Once again, the solvent vapor is passively drawn to coating bead 132 or die 134 by the motion of substrate 16, the motion of fluid 104, by diffusion, or by natural convection.

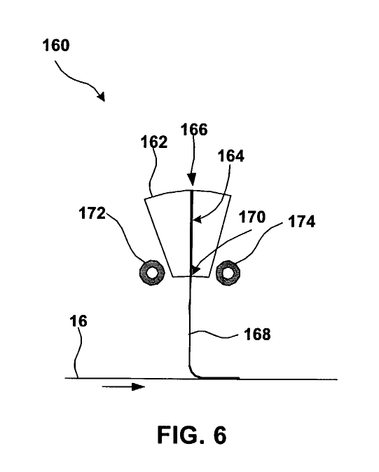

The invention may further be practiced in connection with a curtain coating apparatus 160 shown in FIG. 6. Curtain coating apparatus 160 includes a die 162 with a slot 164 that distributes coating fluid 166 in the form of a curtain 168. Curtain 168 falls through space and coats substrate 16. In contrast to slide coating apparatus 10, extrusion coating apparatus 100 and fluid bearing coating apparatus 130, in which the coating apparatus is proximate to substrate 16, die 162 is removed from substrate 16. The boundary layer of air that is drawn by substrate 16 creates less premature drying with curtain coating than with some other coating techniques, and has less effect upon the quality of coating.

Premature drying may nevertheless adversely affect the performance of curtain coating apparatus 160. In particular, coating solute drying around the opening 170 of slot 164 can affect the consistency and quality of curtain 168. When the consistency and quality of curtain 168 is affected, the quality of the resulting coating may be substandard. To reduce premature drying, curtain coating apparatus 160 may include one or more solvent vapor emission structures 172, 174 near opening 170. Solvent vapor emission structures 172, 174 may be similar to solvent vapor emission device 60 shown in FIG. 2.

Solvent vapor emission structures 172, 174 may be positioned so that solvent vapor is passively introduced proximate to regions where drying may take place. In the embodiment of curtain coating apparatus 160 depicted in FIG. 6, the solvent vapor may be drawn to the sites by diffusion, the motion of falling curtain 168, and/or gravity.

In the context of curtain coating, a saturated gas jet may be less effective than other solvent vapor emission structures because the gas jet may interfere with fluid curtain 168. A solvent vapor emission structure that generates solvent vapor with capillary action, such as solvent vapor emission device 90 shown in FIG. 3, produces no air currents that may disrupt curtain 168. In comparison to a solvent vapor emission structure like solvent vapor emission device 60, however, a capillary action solvent vapor emission device may introduce solvent vapor at a lower rate.

The invention may be advantageous in several respects. The high concentration of solvent vapor near the coating apparatus makes premature drying less likely to occur and less likely to interfere with the coating process. Because solvent vapor may be introduced around coating apparatus passively, there is a reduced risk that introduction of the solvent vapor will disrupt the coating process.

Moreover, the techniques of the invention have been shown to be useful with several different coating techniques, including slide coating, extrusion coating, fluid bearing coating and curtain coating. The invention may be adapted to other coating apparatuses as well.

Various embodiments of the invention have been described. These embodiments are illustrative of the practice of the invention. Various modifications may be made without departing from the scope of the claims. For example, the placement of one or more solvent vapor emission devices as shown in the figures is merely exemplary. In a solvent vapor emission device, energy may be transferred to liquid solvent using techniques other than conducting heat from water. For example, infrared lasers may be used to transfer energy to the liquid solvent and cause the solvent to undergo a state change.

These and other embodiments are within the scope of the following claims.

1. A method comprising:
dispensing a liquid coating with a coating apparatus, the liquid coating including a solvent; and
passively introducing solvent vapor proximate to a site at which the liquid coating comes in contact with the coating apparatus.

2. The method of claim 1, wherein the solvent vapor is passively brought to the site by diffusion.

3. The method of claim 1, wherein the solvent vapor is passively brought to the site by natural convection.

4. The method of claim 3, wherein bringing solvent vapor passively to the site by natural convection comprises bringing solvent vapor passively to the site by at least one of a thermal gradient, gravity and buoyancy.

5. The method of claim 1, wherein passively introducing solvent vapor includes passively introducing the solvent vapor via a boundary layer adjacent a coating substrate.

6. The method of claim 1, further comprising:
increasing a concentration of solvent vapor in a boundary layer proximate to a substrate; and
introducing the solvent vapor proximate to the site by moving the substrate toward the site.

7. The method of claim 6, wherein increasing the concentration of solvent vapor in the boundary layer proximate to the substrate comprises solvent vapor comprises blowing gas including solvent vapor onto the substrate.

8. The method of claim 6, wherein increasing the concentration of solvent vapor in the boundary layer proximate to the substrate comprises skimming off a portion of the boundary layer from the substrate.

9. The method of claim 1, wherein passively introducing solvent vapor comprises:
drawing liquid solvent from a liquid solvent supply; and
evaporating the liquid solvent.

10. The method of claim 9, further comprising evaporating the liquid solvent by transferring energy to the liquid solvent.

11. The method of claim 9, wherein drawing the liquid solvent from the liquid solvent supply comprises drawing the liquid solvent with capillary action.

12. An apparatus comprising:
a coating apparatus, including an exposed surface that comes in contact with a liquid coating including a solvent; and
a solvent vapor emission device that emits solvent vapor, and passively introduces the solvent vapor to the exposed surface of the coating apparatus.

13. The apparatus of claim 12, wherein the solvent vapor emission device comprises a saturated gas jet.

14. The apparatus of claim 13, wherein the apparatus receives a moving substrate, wherein the saturated gas jet blows gas including solvent vapor onto the substrate and wherein the solvent vapor is brought to the exposed surface as part of a boundary layer adhering to the substrate.

15. The apparatus of claim 13, wherein the saturated gas jet emits the solvent vapor.

16. The apparatus of claim 12, wherein the solvent vapor emission device comprises:
a first tube containing a fluid; and
a second tube containing a liquid solvent, wherein the liquid solvent receives energy from the first tube and vaporizes to produce solvent vapor, and wherein the second tube includes an aperture for escape of the solvent vapor.

17. The apparatus of claim 12, wherein the solvent vapor emission device comprises:
a reservoir of liquid solvent;
a material that draws the liquid solvent with capillary forces from the reservoir to a point near the exposed surface and emits solvent vapor by evaporation proximate to the exposed surface.

18. A device comprising:
a first tube containing an energy transfer element; and
a second tube containing a liquid solvent, wherein the liquid solvent receives energy from the first tube and vaporizes to produce solvent vapor, and wherein the second tube includes an aperture for escape of the solvent vapor.

19. The device of claim 18, wherein the second tube encloses the first tube.

20. The device of claim 18, wherein the energy transfer element comprises a heated fluid.

21. The device of claim 20, wherein the heated fluid is liquid water.

22. The device of claim 18, wherein the solvent is at least one of tetrahydrofuran, methylene chloride, acetone, methyl ethyl ketone, methyl isobutyl ketone, ethyl acetate, butyl acetate, cyclohexanone, butyl alcohol, and N,N-dimethylformamide, toluene.

23. A device comprising:
a reservoir of liquid solvent;
a material that draws the liquid solvent with capillary forces from the reservoir to a target area and emits solvent vapor by evaporation proximate to the target area.

24. The device of claim 23, wherein the material comprises at least one of a wick, porous foam material, absorbent paper and absorbent cloth.

25. The device of claim 23, further comprising a baseplate, the baseplate supporting the material that draws the liquid solvent with capillary forces.

26. The device of claim 23, further comprising a hood that encloses the material that draws liquid solvent with capillary forces.

27. The device of claim 23, wherein the solvent is at least one of methylene chloride, acetone, methyl ethyl ketone, methyl isobutyl ketone, ethyl acetate, butyl acetate, cyclohexanone, butyl alcohol, and N,N-dimethylformamide, toluene.
